(19) United States
(12) Patent Application Publication
(10) Pub. No.: US 2025/0315730 A1
(43) Pub. Date: Oct. 9, 2025

(54) SYSTEMS AND METHODS FOR A DECISION ENGINE FOR DETERMINING DATA-POINT RECOMMENDATIONS

(71) Applicant: STATS LLC, Chichago, IL (US)

(72) Inventors: Nicholas Peter COCKERILL, Roberttown (GB); Stephen Andrew SKWERES, Highland Park, IL (US); Thomas BRUGGER, Graz (AT)

(73) Assignee: STATS LLC, Chicago, IL (US)

(21) Appl. No.: 19/098,505

(22) Filed: Apr. 2, 2025

Related U.S. Application Data
(60) Provisional application No. 63/574,654, filed on Apr. 4, 2024.

(51) Int. Cl. G06N 20/00

(52) U.S. Cl. CPC G06N 20/00

(57) ABSTRACT

A method for generating recommended user content related to a sporting event, the method including: receiving, as input, digital sports content of one or more sporting events; receiving, as input, sports event data for the one or more sporting events; receiving, as input, a set of statistical odds for the one or more sporting event; determining, using a decision engine, based on the received input digital sports content and sports event data, recommended statistical odds for one or more sporting events; determining, using the decision engine, recommended contextual content based on the determined recommended statistical odds; and outputting the recommended contextual content and recommended statistical odds to one or more users.

### CROSS-REFERENCE TO RELATED APPLICATIONS

This application claims the benefit of priority to U.S. Provisional Patent Application No. 63/574,654, filed Apr. 4, 2024, the entirety of which is incorporated by reference herein.

### TECHNICAL FIELD

Various aspects of the present disclosure relate generally to machine learning for sports applications. In particular, various aspects relate to machine learning techniques for systems and methods for a decision engine for determining data-point recommendations.

### INTRODUCTION

Currently, sports content providers deliver a hierarchical and relatively static experience. Although statistical odds and relevant content for a sporting event change continuously through a given match, a sports content provider's output is still inherently ‘catalogue based’ such that a customer has to scroll through long lists of content to find what they desire to view. This may not align with user expectations, especially on smart phones where the prevalence of news feeds and short form videos capture user attention much more effectively than static content.

Unless otherwise indicated herein, the techniques and information described in this section are not prior art to the claims in this application and are not admitted to be prior art, or suggestions of the prior art, by inclusion in this section.

### SUMMARY

In some aspects, techniques described herein relate to a method for generating recommended user content related to a sporting event, the method including: receiving, as input, digital sports content of one or more sporting events; receiving, as input, sports event data for the one or more sporting events; receiving, as input, a set of statistical odds for the one or more sporting event; determining, using a decision engine, based on the received input digital sports content and sports event data, recommended statistical odds for one or more sporting events; determining, using the decision engine, recommended contextual content based on the determined recommended statistical odds; and outputting the recommended contextual content and recommended statistical odds to one or more users.

In some aspects, techniques described herein relate to a method, wherein the recommended statistical odds are determined from the set of statistical odds.

In some aspects, techniques described herein relate to a method, wherein the digital sports content includes: video highlights, news right videos, editorial, insights, graphic visuals, statistics of the one or more sporting events, and/or visual outputs of the one or more sporting events.

In some aspects, techniques described herein relate to a method, wherein the sports event data includes real time statistical data for the one or more sporting events.

In some aspects, techniques described herein relate to a method, further including: receiving as input, a second set of sports event data for the one or more sporting events; a second set of digital sports content of the one or more sporting event, and a second set of statistical odds for the one or more sporting event; determining, using the decision engine, a second set of recommended contextual content and second set of recommended statistical odds for the one or more sporting events; and outputting the second set of recommended contextual content and second set of recommended statistical odds to the one or more users.

In some aspects, techniques described herein relate to a method, wherein the decision engine uses machine learning techniques to determine at least one of the recommended statistical odds or the recommended contextual content.

In some aspects, techniques described herein relate to a method, wherein the decision engine uses rules-based decision making techniques to determine at least one of the recommended statistical odds or the recommended contextual content.

In some aspects, techniques described herein relate to a method, further including: determining at least two recommended contextual content outputs; ranking the two recommended contextual content outputs based on determined relevance; and outputting a higher ranked of the two recommended contextual content outputs.

In some aspects, techniques described herein relate to a method, wherein the recommended contextual content includes at least two types of content, the types of content including: video highlights, news right videos, editorial, insights, graphic visuals, statistics of the one or more sporting events, and/or visual outputs of the one or more sporting events; and pairing the at least two types of content together for output.

In some aspects, techniques described herein relate to a method, wherein the recommended contextual content includes a visual graphic created to depict the received sports event data.

In some aspects, techniques described herein relate to a system for associating a player with a team in a sports event, the system including: a memory configured to store processor-readable instructions; and a processor operatively connected to the memory, and configured to execute the instructions to perform operations including: receiving, as input, digital sports content of one or more sporting events; receiving, as input, sports event data for the one or more sporting events; receiving, as input, a set of statistical odds for the one or more sporting event; determining, using a decision engine, based on the received input digital sports content and sports event data, recommended statistical odds for one or more sporting events; determining, using the decision engine, recommended contextual content based on the determined recommended statistical odds; and outputting the recommended contextual content and recommended statistical odds to one or more users.

In some aspects, techniques described herein relate to a system, wherein the recommended statistical odds are determined from the set of statistical odds.

In some aspects, techniques described herein relate to a system, wherein the digital sports content includes: video highlights, news right videos, editorial, insights, graphic visuals, statistics of the one or more sporting events, and/or visual outputs of the one or more sporting events.

In some aspects, techniques described herein relate to a system, wherein the sports event data includes real time statistical data for the one or more sporting events.

In some aspects, techniques described herein relate to a system, wherein the operation further include: receiving as input, a second set of sports event data for the one or more sporting events; a second set of digital sports content of the one or more sporting event, and a second set of statistical odds for the one or more sporting event; determining, using the decision engine, a second set of recommended contextual content and second set of recommended statistical odds for the one or more sporting events; and outputting the second set of recommended contextual content and second set of recommended statistical odds to the one or more users.

In some aspects, techniques described herein relate to a system, wherein the decision engine uses machine learning techniques to determine at least one of the recommended statistical odds or the recommended contextual content.

In some aspects, techniques described herein relate to a system, wherein the decision engine uses rules-based decision making techniques to determine at least one of the recommended statistical odds or the recommended contextual content.

In some aspects, techniques described herein relate to a non-transitory computer readable medium configured to store processor-readable instructions, wherein when executed by a processor, the instructions perform operations including: receiving, as input, digital sports content of one or more sporting events; receiving, as input, sports event data for the one or more sporting events; receiving, as input, a set of statistical odds for the one or more sporting event; determining, using a decision engine, based on the received input digital sports content and sports event data, recommended statistical odds for one or more sporting events; determining, using the decision engine, recommended contextual content based on the determined recommended statistical odds; and outputting the recommended contextual content and recommended statistical odds to one or more users.

In some aspects, techniques described herein relate to a non-transitory computer readable medium, wherein the recommended statistical odds are determine from the set of statistical odds.

In some aspects, techniques described herein relate to a non-transitory computer readable medium, wherein the digital sports content includes: video highlights, news right videos, editorial, insights, graphic visuals, statistics of the one or more sporting events, and/or visual outputs of the one or more sporting events

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a tracking and analytics computing environment, according to example embodiments.

FIG. 2 is a block diagram of an exemplary sport's content provider environment, according to example embodiments.

FIG. 3 is an exemplary flow diagram for sports content output, according to example embodiments.

FIG. 4 is an exemplary box diagram representing a trigger event and desired output for the sports content provider environment, according to example embodiments.

FIG. 5 is an exemplary flow diagram of the sports content provider's output during a sporting event, according to example embodiments.

FIG. 6 is an exemplary flow diagram of the sports content provider's output based on a player's actions during a sporting event, according to example embodiments.

FIG. 7A-7C are exemplary block diagrams of a user interface output, according to example embodiments.

FIG. 8 is an exemplary block diagram of a user interface output including statistical odds and commentary, according to example embodiments.

FIG. 9 is an exemplary block diagram of a user interface output including statistical odds and match statistics, according to example embodiments.

FIG. 10 is an exemplary block diagram of a user interface output including a match preview, according to example embodiments.

FIG. 11A-11B are exemplary block diagrams of a user interface output including facts and corresponding statistical odds, according to example embodiments.

FIG. 12 is an exemplary block diagram of a user interface output including statistical odds and corresponding statistics, according to example embodiments.

FIG. 13 depicts a flow diagram for training a machine-learning model, according to example embodiments.

FIG. 14A is a block diagram illustrating a computing device, according to example embodiments.

FIG. 14B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to machine learning for sports applications. In particular various aspects relate to machine learning techniques for systems and methods for a decision engine for determining data-point recommendations.

According to embodiments disclosed herein, a decision engine may receive inputs, wherein the inputs may include sporting content for one or more sporting events, statistical odds for the one or more sporting events, and/or match/event data for the one or more sporting events. The sporting content may include automated insights, match previews, video content, images, editorials, statistics, tracking data, event data, and/or data visualization for a sporting event. Match/event data may include live statistics for a team (e.g., score, passes, penalties, time of possession, injury report, etc.) or for a player (shots, goals, passes, assists, penalties, time on the field, etc.). Both the sporting content and match/even data may be associated with one or more statistical odds related to a player, team, and/or match. For example, the data may be related to a specific player who has statistically improved in recent games as compared to historical data. A dialogue may be provided to a user that flags the statistical odds such as, for example, “have you considered placing a sports book related market submission related to [Player A] because of related data points and/or insights [Y] and [Z]?” The decision engine may output recommended content and/or statistical odds for the sporting event temporally throughout a sporting event. The output content may include recommended contextual content such as video highlights, news highlights, editorials, sporting event insights, graphical visuals, and/or output statistics that correspond with a recommend statistical odd. The output statistics may be relevant to broader sports engagement such as sports book market related submissions. Insights may then be generated relative to the updated statistics. The output may, for example, be provided in a news-feed format. The decision engine may be configured to utilize rules-based and/or machine learning techniques. The output recommendations may be updated automatically based on the received input before, during, and after a particular sporting event. The recommended content may be specifically generated for a particular user or for users in general.

Conventional sports content providers may provide static content that needs to be manually procured. The challenge for conventional sports providers may be that producers do not produce much of the content they rely on to engage users themselves. For example, the data points, statistics, insights and video may be provided by third parties. This means that content providers may not be able to ingest, process and output content in a way that would facilitate a ‘news feed’ style experience.

Conventional sport's content providers may rely on manually typing ‘insights’ next to relevant markets in the trading notes in legacy administrative consoles. This may result in a sub-optimal user experience (such that it may require browsing and the output may be inconsistent) and is not scalable (e.g., due to the requirement for manual input).

One or more embodiments of the system described herein may receive, as inputs, statistical data, sports content, and/or event data for a sporting event. The system may be configured to utilize a decision engine to determine when to alter, combine, and/or output particular pieces of received content. This may occur prior to, during, or after the sporting event. For example, as events occur during the sporting event and additional data is received, data that is determined to be engaging to one or more users may be organized and output to one or more users.

While soccer and various aspects relating to soccer (e.g., a predicted total number of passes by a team during a game) are described in the present aspects as illustrative examples, the present aspects are not limited to such examples. For example, the present aspects can be implemented for other sports or activities, such as American football, basketball, baseball, hockey, tennis, rugby, cricket, golf, team sports, individual sports, and so forth.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section

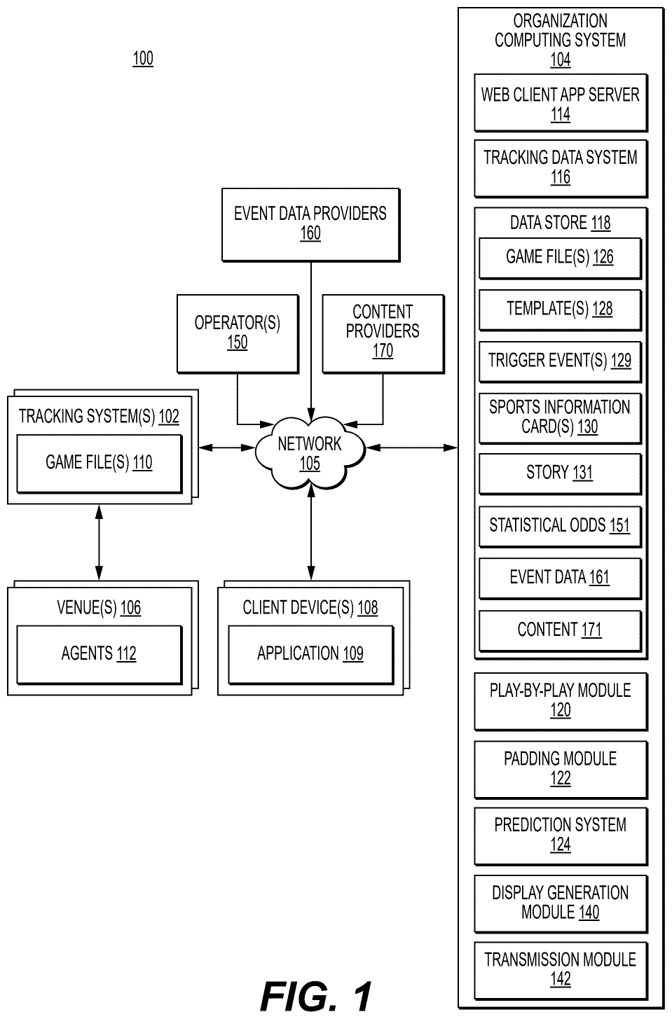

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105. The environment 100 described herein may utilize a rules-based system and/or a machine learning system(s) to generate sports content for one or more users based upon received content and event data. This content may be generated prior to a sporting event, during a sporting event or after the sporting event.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession-based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. The organization computing system 104 may further process additional data retrieved by external sources (e.g., operator(s) 150, event data providers 160, and content providers 170) as will be discussed in more detail below. Organization computing system 104 may include at least a web client application server 114, tracking data system 116, data store 118, play-by-play module 120, padding module 122, prediction system 124, display generation module 140, and/or transmission module 142. Each of the tracking data system 116, data store 118, play-by-play module 120, padding module 122, prediction system 124, display generation module 140, and/or transmission module 142 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such a process, organization computing system 104 may go beyond the generation of tracking data from broadcast video data. Instead, to provide descriptive analytics, as well as a useful feature representation for prediction system 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

Data store 118 may be configured to store one or more game files 126, template(s) 128, trigger event(s) 129, sports information card(s) 130, story 131, statistical odds 151, event data 161, and content 171. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

The templates 128 may include one or more templates (e.g., requirements, formats, layouts, models, samples, or guides) for sports media content (e.g., sports information cards). In some aspects, a template 128 may define how content (e.g., text, or one or more graphics, notifications, images, video, audio, interactive elements, or the like) is to be presented or played, how the content is to be presented or played, and/or when the content is to be presented or played, in or adjacent to a sports information card, for example. In some embodiments, a template 128 may be determined by, or customized for, a specific entity/client (e.g., a sports news company). For example, a sports news company may determine that the content of a template 128 should reflect the sports news company's brand (e.g., trademark, logo, and/or certain colors, sounds, or graphics) or a particular look and feel. In some embodiments, a template 128 may specify text such as commentary that is generated (i) automatically by a processor or machine learning model (e.g., a first machine learning model in prediction system 124) and/or (ii) manually by a journalist or other person. Further, in some embodiments, a template 128 may specify one or more insights (e.g., metrics, facts, predictions displayed using text and/or graphics), such as the leading or highest performing player of a game, particular game statistic(s), a line-up, goal(s), pass(es), expected goal(s), or expected pass(es). Further, in some embodiments, a template 128 may specify one or more graphics such as a goal-sequence or a heat map, and/or the formatting of one or more graphics (e.g., landscape or portrait mode, resolution, or the like). Further, in some embodiments, a template 128 may be associated with one or more trigger events 129, such that if the occurrence of one or more of the trigger events 129 is detected in event data (e.g., output from the tracking system 102 and/or the tracking data system 116), the template 128 is to be automatically applied (or populated or filled) to generate sports media content (e.g., a sports information card). For example, a template 128 may be associated with a trigger event 129 representing a goal that is scored, such that if occurrence of the trigger event 129 is detected in event data, the template 128 may be automatically applied, optionally to output of the predictions system 124, to generate a sports information card that is configured to include or be positioned adjacent to a marker (or placeholder) for an interactive element (e.g., an advertisement, sponsorship, market-based prediction offer, or the like), in a sports content stream of an interactive display. In such example, the interactive element may optionally be inserted by a third party, in the sports content stream where indicated by the marker. As another example, a template 128 may be associated with a trigger event 129 representing a goal that is scored, such that if occurrence of the trigger event 129 is detected in event data, the template 128 may be automatically applied, optionally to output of the prediction system, to generate a sports information card that includes, or is positioned adjacent to, an interactive element (rather than a placeholder for an interactive element) in a sports content stream of an interactive display. In some embodiments, a template 128 may specify that a sports information card is to include (i) a placeholder for an interactive element, or (ii) an interactive element, where the interactive element is relevant (or corresponds to or matches) user data, which may correspond to a user of the client device 108. In such embodiments, when the sports information card includes the interactive element and is presented, to the user via the client device 108, the interactive element may be customized (or personalized) for the user.

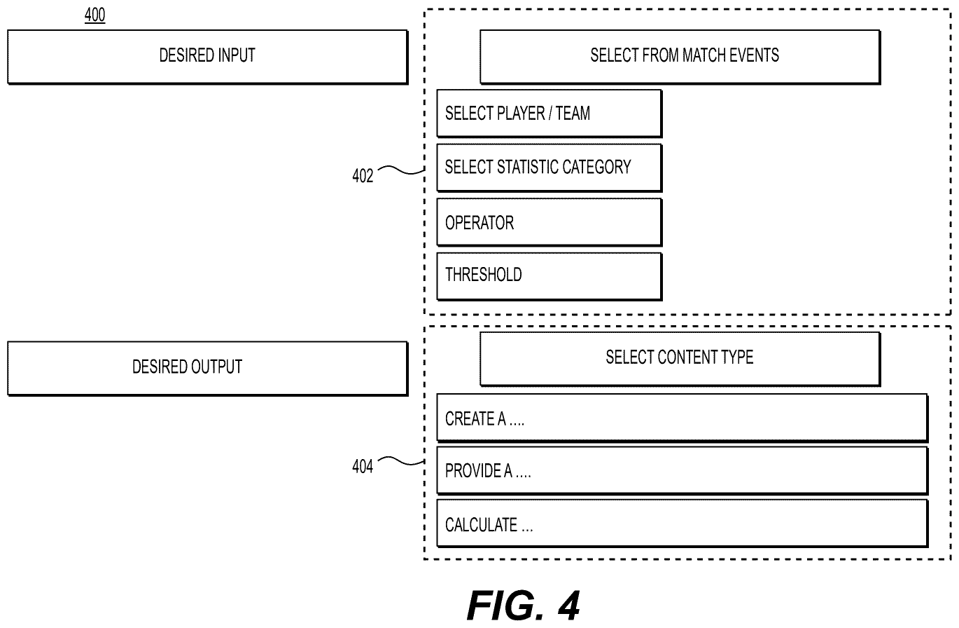

The trigger events 129 may include data representing one or more events, categories of events, or types of events (also referred to herein as “event types”). When the occurrence of the one or more events or types of events is detected in tracking data, event data, a post-game summary, or other data (e.g., by the tracking system 102, the tracking data system 116, or the prediction system 124), corresponding sports media content (e.g., a sports information card) may be determined for output. For example, particular recommended statistical odds and recommended contextual content may be associated with a particular trigger event. In some embodiments, a trigger event 129 may represent a natural language prompt (e.g., “Generate a sports information card regarding Lebron James.”) received from, for example the client device 108. In some aspects, when the occurrence of a trigger event 129 is detected, a corresponding (or associated) sports media content (e.g., a sports information card) may be generated using, for example, the prediction system 124, and a template 128. In some embodiments, a trigger event 129 may represent, for example, a particular game statistic, metric, or feature (e.g., a particular number of goals, points, hits, or touchdowns, an expected number of goals, hits, points, or touchdowns, an expected possession, a line-up, a first half kickoff, a time representing half time, a time representing full time, a probability of a win, a kick off, a level of fans' excitement determined from excitement data, or the like). In some embodiments, one or more trigger events 129 may be pre-determined (e.g., manually defined in advance by an entity associated with the organization computing system 104, or a third party). This may be discussed in greater detail in FIGS. 4-6. Further, in some embodiments, the one or more trigger events 129 may be dynamically determined using, for example, a machine learning model of prediction system 124. In some embodiments, tracking data, event data, a post-game summary, or other data may be analyzed continuously or periodically (e.g., at a certain frequency) by one or more of the tracking system 102, the tracking data system 116, or the prediction system 124, to detect or identify the occurrence of one or more trigger events 129. In some embodiments, a trigger event 129 may be associated with (e.g., correspond to) one or more templates 128.

The sports information card(s) 130 may include one or more distinct sets of data, where each distinct set of data may include event data, tracking data, statistics, summaries, and/or the like, configured to be presented in textual (e.g., dialogue) or graphical form within a sports content stream (or user interface). The sports information card(s) 130 may include the recommended contextual content and recommended statistical odds for one or more users. In some embodiments, a sports information card 130 may be generated by the prediction system and/or the display generation module 140. Further, in some embodiments, a sports information card 130 may be modified (e.g., edited to include an interactive element such as an advertisement, sponsorship, or market-based prediction opportunity) by a third party.

The story (or stories) 131 may include data representing one or more sports media stories that include one or more of an image, video, audio, text, and/or an interactive element. In some embodiments, a story 131 may be generated by the prediction system 124 (optionally using a template 128) or the display generation module 140. The story 131 may represent a flow of generated sports information card(s) output to a user through a news-feed user interface.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

The prediction system 124 may be configured to generate recommended user content related to a sporting event. In some examples, the prediction system 124 may implement one or more machine learning to generate recommended user content. In other examples, the prediction system 124 may implement rules-based algorithms to generate content for users. For example, upon the occurrence of one or more trigger events 129, the prediction system 124 may implement one or more templates 128 to form or generate one or more sports information card 130. The prediction system 124 may be configured to output the one or more sports information cards 130 as part of a story 131. For example, these may be output to one or more user devices.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

The display generation module 140 may be configured to generate an interactive display using data received by the prediction system 124. The interactive display may represent an interactive user interface in which one or more sports information cards, sports media stories, markers, or interactive elements, are presented (e.g., within a sports content stream of the interactive display). In some embodiments, the display generation module 140 may be configured to embed, using one or more codes, one or more sports information cards, sports media stories, or interactive elements in an interactive display.

The transmission module 142 may be configured to transmit an interactive display (or sports content stream) generated using the display generation module 140 to one or more of the third entity system or the client device 108 for further processing and/or display on a display screen.

One or more external servers may be in communication with organization computing system 104 via network 105. This may include operator(s) 150, event data providers 160, and content providers 170. The operator(s) 150 may include one or more servers configured to provide statistical odds related to one or more sporting events. These may include predictions for upcoming games and live games. The statistical odds may be related to game outcomes, player statistics, and/or team statistics. The statistical odds may further be related to season performances (e.g., odds of making the playoffs or winning the playoffs). Each of the statistical odds may be associated with one or more sporting player, sporting team, and/or sporting event match.

The event data provider 160 may include one or more servers configured to provide live event actions and/or statistics of events during one or more sporting events. This may include event data about the match, a team, or a player. An example input may be action just performed in a game. For example, for an exemplary soccer game, when a player goals, event data indicating the time of goal, player that scored, individual who assisted the goal, type of shot, location of shot, etc. may be output to the computing system 104.

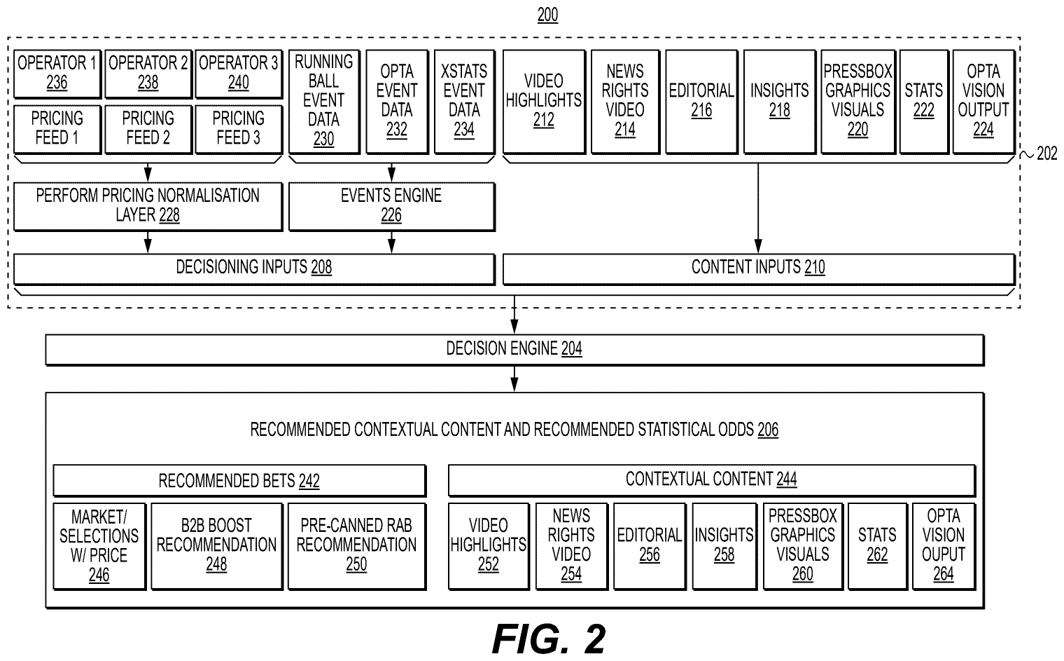

The content provider 170 may include one or more servers configured to provide content related to one or more sporting events. The content may be related to one or more players and/or teams in a sporting event. For example, the content may include, but is not limited to, may include video highlights, news right videos, editorials, insights, graphic visuals, statistics including both raw collected data and derivative metrics, and vision outputs. These may be further discussed in FIG. 2 below.

The data provided by the operator(s) 150, event data providers 160, and content providers 170 may be saved within the data store 118 for utilization by the computing system 104. For example, statistical data from the operator 150 may be saved as statistical odds 151 in the data store 118. Event data from the event data providers 160 may be stored as event data 161 in the data store 118. Content from the content provider(s) 170 may be stored as content 171 in the data store 118. Further, event data generated by the computing system 104 may be saved as event data 161.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 109. Application 109 may be representative of a web browser that allows access to a website or a stand-alone application. Client device 108 may access application 109 to access one or more functionalities of organization computing system 104. Client device 108 may communicate over network 105 to request a webpage, for example, from web client application server 114 of organization computing system 104. For example, client device 108 may be configured to execute application 109 generate recommended user content by the prediction system 124. The content that is displayed to client device 108 may be transmitted from web client application server 114 to client device 108 and subsequently processed by application 109 for display through a graphical user interface (GUI) of client device 108.

FIG. 2 is a block diagram of an exemplary sports content provider environment 200, according to example embodiments. The content provider environment 200 may implement and/or include one or more components of environment 100 as will be described in greater detail below. The content provider environment 200 may be configured to receive statistical data, content, and/or match/event data as input for a sporting event. The content provider environment 200 may be configured to organize, combine, and create content output for one or more users. This may include statistical odds, video highlights, editorials, insights, graphic visuals, relevant statistics. The content provider environment 200 may include an input module 202, a decision engine 204, and output module 206.

The input module 202 may include one or more servers/components configured to provide inputs to the decision engine 204 of the content provider environment 200. In some examples, the received input may be from operator(s) 150, event data provider 160, and/or content provider(s) 170. The input module 202 may be configured to output decision inputs 208 and content inputs 210 to a decision engine 204. The decision inputs 208 may include statistics 228 and event engine inputs 226.

The statistics 228 may include statistical odds of particular events occurring in a game. For example, statistics 228 may include predicted outcome of sporting events (e.g., game winner, the score of the game, etc.), or the statistical odds of a particular event occurring (e.g., a player scoring, assisting, performing a set number of passes). The statistics 228 may be received (e.g., via network 105) from one or more external operators (e.g., operator 1 236, operator 2 238, and/or operator 3 240). In some examples, the operators (e.g., operator 1 236, operator 2 238, and/or operator 3 240) may be operator(s) 150 from FIG. 1. The statistics 228 may further be received internally from the data store 118.

The event engine inputs 226 may include event data including runningball event data 230, opta event data 232, and xstat event data 234. The event engine inputs 226 may include live statistics of one or more sporting events. This may include event data about the match, a team, or a player. The match data may include: the time left in the game, the score of the game, the amount of fouls/penalties in a game, the players involved in the sporting match, the referee(s) assigned, sporting surface information, etc., it may also extend to artificial intelligence (“AI”) powered derived metrics such as ‘match momentum’ or ‘xG’ (defined as expected goals predicted for a team) which are calculated as an output of analysis of myriad factors. The player data may include, for example, data regarding each player's projected and/or current goals, assists, passes, penalties, saves, time on the field, etc. Runningball event data 230 may refer to data uploaded by a scout at a sporting event. Opta event data 232 may be generated by the tracking system 102 or a team of scouts and quality assurance (“QA”) analysts in stadium or via remote viewing. The Xstat event data 234 may refer to additional data received externally via network 105 (e.g., received via event data provider(s) 160 of FIG. 1).

The content input 210 may include video highlights 212, news right videos 214, editorials, 216, insights 218, graphic visuals 220, statistics 222 including both raw collected data and derivative metrics, and vision outputs 224. Video highlights 212 may include videos such as highlights of one or more sporting events. The video highlights 212 may be created live or of a past sporting event. News right videos 214 may refer to videos of press conferences prior to and after a sporting event. The editorials 216 may include written work expressing opinion or expression related to a sporting event or one or more athletes. Editorials 216 may be written work describing a sporting event. The editorials 216 may be created prior to a sporting event. The insights 218 may include analytical observations of a player or team based on data or sports expertise. For example, the insights 218 may include outputs on whether a player obtained or is associated with a predicted metric in a game. Player A may be predicted to score in a game and an insight may be generated if player A scores and reaches such a predicted metric. Graphic visuals 220 may include visuals depicting players and teams and their statistical outputs over a period of time. Statistics 222 may refer to received historical player or team data. Vision output 224 may refer to the output from the tracking system 102. Vision output 224 may further include recreation of events such as a three-dimensional rendering of a particular goal scored in a game. Each of inputs related to content input 210 may include associated metadata tying the particular input to one or more players, teams, or sporting events. For example, a video of a goal scored during a game may include metadata indicating which game the goal occurred during, the time of the goal, the player that scored, the type of shot, etc. In some examples, the content input may be retrieved by the content provider(s) 170 of FIG. 1.

The decision engine 204 may receive the statistics, event data, and content inputs from the input module 202 described above. The decision engine 204 may be configured to generate recommended user content related to one or more sporting events. In some examples, the content inputs 210 may be associated with related decisioning inputs 208 for output. The decision engine 204 may be implemented by the computing system 104 of FIG. 1.

The decision engine may be configured to generate a score based on received inputs (e.g., statistics, event data, and content input). The score may be utilized to rank and calculate an expected rate of engagement by one or more users for output content and/or statistics. In some examples, scores may be assigned jointly to outputs of the decision engine. For example, a video and corresponding statistic may be generated by the decision engine for output. A single score may be assigned to the video and statistics, as the content and statistics may be output together to a user. In some examples, generated content and statistics may need to have a score above a threshold value in order to be output to one or more users. In some examples, the score may be utilized to prioritize the order in which content and statistics are output to one or more users. In some example, scores may be based, in part, on received event data considered to be high engagement (e.g., goals) to a user. When content and statistics are generated based on higher engagement event data, this may lead to the decision engine assigning a higher score to the generated content and/or statistics.

As events happen in a sporting event, data points (derived and raw from the input module 202) may be identified by the decision engine 204 that are interesting/likely to be engaging to end users. The decision engine 204 may generate outputs determined to be of a highest engagement level and most relevant to one or more users. The decision engine 204 may calculate which pieces of content should be combined and output. The output may be general or user specific (e.g., based on a particular user's preferences). The decision engine 204 may utilize the prediction system 124 of FIG. 1 and include a rules-based system and/or machine learning models determine one or more recommended outputs as discussed in greater detail below.

The decision engine 204 may, for example, utilize rules-based decision making. For example, the decision engine 204 may include a set of triggering events (e.g., trigger events 129 in the data store 118 of FIG. 1). The trigger events may include rules for what to output when particular inputs are received. For example, an exemplary trigger event may be that when event data indicates a goal has been scored, to output a video highlight of the particular goal. The trigger events may determine what outputs should be prioritized. For example, the trigger events may prioritize outputs related to goals and end of matches as compared to passes and general statistics of a match.

In another example, the decision engine 204 may generate output based on machine learning techniques (e.g., via the machine learning models of the prediction system 124 of FIG. 1). The machine learning models may be trained on a set of rules-based trigger events along with user engagement to previously determined content. The machine learning techniques may further refine output predictions based on user interactions with the output generated by the decision engine 204. This may lead to user specific determined outputs.

The decision engine 204 may output, though the output module 206, recommended statistical odds 242 and/or recommended contextual content 244. For example, the output module 206 may be implemented by one or more client device(s) 108. The recommended statistical odds 242 may be related to the recommended contextual content 244. For example, if player A scores a goal during a soccer game, the live updated odds of player A scoring another goal may be output as recommended statistical odds 242 with a video of the goal scored e.g., the recommended contextual content 244.

The recommended statistical odds 242 may refer to statistical odds that may be relevant or determined to be engaging to one or more users. The recommended statistical odds 242 may include selection and market statistics 246, boosted recommendation 248, and pre-canned RAB recommendations 250. For example, the selection statistics 246 may refer to engaging statistics for a user. For example, selection statistics 246 may include live game odds updates that occur during a sporting event. The selection statistics 246 may also include relevant upcoming sporting events. For example, selection statistics 246 may include statistics for games between two teams with the highest records (e.g., the relevant statistics for the top two seeded games in a certain sports league) may be a suggested output. The boost recommendation 248 may refer to statistical outputs that have been enhanced and provide increased statistical odds for a user. Such a boost recommendation 248 may be based on a user profile such that the boost recommendation 248 may align with user preferences, user ratings, user associated teams and/or players, and/or the like. Alternatively, or in addition, a machine learning model may receive a set of recommendations and may output a subset of such recommendations as boost recommendations 248. The machine learning model may identify the subset of the recommendations based on a likelihood of engagement by a given user based on historical engagements with similar types of recommendations that are part of a training data set that is used to train the machine learning model is. The pre-canned recommendations 250 may refer to groupings of statistical odds that have been grouped together and may be output to a user. In some examples, the decision engine 204 may be configured to determine these groupings. In some examples, the groupings may be imported from an external source.

The contextual content 244 may include video highlights 252, news right videos 254, editorials 256, insights 258, graphic visuals 260, statistics 262, and vision output 264. The contextual content 244 may include the components of the content inputs 210. The contextual content 244 may be a subset of the content inputs 210 that are associated with the decision inputs 208. For example, decision engine 204 may receive the content inputs 210 and may extract a subset of the content inputs that are associated with the decision inputs 208. Decision engine 204 may send only the subset of the content inputs 210 to the output module 206 that corresponds to the sporting events associated with the decision inputs 208. Accordingly, the content inputs 210 may be filtered such that only the content associated with relevant odds and statistics are provided to the output module 206.

In some examples, the recommended statistical odds 242 may be output with corresponding contextual content 244. For example, a video highlight of player X scoring may be output along with the statistical odds that player X scores in the second half of a live sporting event. The output module 206 may output the determined content via a client device(s) 108.

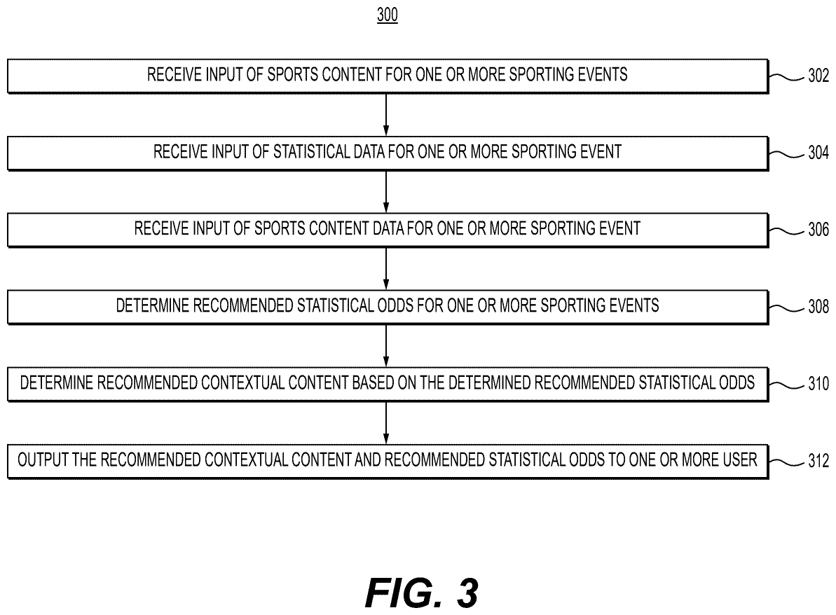

FIG. 3 is an exemplary flow diagram of a method 300 for generating recommended user content related to a sporting event, according to example embodiments. The method 300 may be implemented by aspects of the content provider environment 200 of FIG. 2 and or by the environment 100 of FIG. 1. The method of FIG. 3 may be applied prior to, during, or after a sporting event occurs. In some examples, the method of FIG. 3 may be applied constantly throughout a sporting event to generate a stream of recommended user content throughout a sporting event.

At step 302, the system may receive sports content input (e.g., by content provider 170 of FIG. 1) for a sporting event (e.g., one sporting event or one or more sporting events). For example, the system may receive one or more of the content inputs 210 described in FIG. 2. The content input may include video highlights, news right videos, editorials, insights, graphic visuals, statistics, and vision output related to the sporting event. The content inputs may be for a past, current, and/or future sporting event.

At step 304, the system may receive statistical data (e.g., by operator(s) 150 of FIG. 1) for the sporting event (e.g., one sporting event or one or more sporting events). The statistical odds may include the odds that a player or team may perform a certain action. For example, team statistics may include odds that a team wins, scores a certain number of goals, has a certain time of possession, etc. The player statistics may include predicted goals, shots, passes, assists, turnovers, time of possession, shots from particular areas of the field (e.g., from inside or outside the box in a soccer match). The system may receive statistical odds prior to the game. The system may receive live/updated statistical odds throughout the sporting event.

At step 306, the system may receive sports event data (e.g., by event data providers 160 of FIG. 1) for the sporting event (e.g., one sporting event or one or more sporting events). Event data may refer to defined actions that occur in a sporting event. The sporting event data may indicate the occurrence of an event during the sporting event and the time that the event took place. The sporting event data may further indicate what player(s) were involved in the sporting event data. Exemplary event data for a soccer game may include a kickoff, a pass, a tackle, a steal, a shot on goal, a goal, a goalkeeper save, a foul, a free kick, a penalty kick, a corner kick, a throw in, an offsides, a yellow card, a red card, a substitution, half time, and a final whistle. The sports event data may be provided in real time (e.g., within thirty seconds of the event occurring). The sports event data may further include or may be generated based on tracking data as discussed herein. The tracking data and/or corresponding event data may be based on players and/or objects (e.g., a ball, puck, etc.) and their respective movements, positions, trends, and projections as determined during data sporting event. In some examples, the event data may be collected, recorded, and aggregated throughout a game. This may include saving how many actions particular players and/or teams have performed. This may allow for recommended contextual content and recommended statistical odds to be determined once a set number of a particular events has occurred.

In some examples, event data may be received from a separate server (e.g., by event data providers 160). In another example, event data may be automatically determined based on analysis of tracking data (e.g., as determined by the computing system 104). Tracking data may be received in a first format (e.g., a digitized format) based on video feeds output by tracking systems. The tracking data may then be converted to a second format as event data implementing the techniques discussed in FIG. 1. In another example, event data may be automatically determined based on analysis of broadcast information received (e.g., as determined by the computing system 104). Broadcasts feed may be received in a first format (e.g., a video format) based on video feeds received. The broadcast feed may then be converted to a second format as event data implementing the techniques discussed in FIG. 1.

Steps 302, 304, and 306 may occur simultaneously and/or at variable rates throughout the sporting event. For example, the system may receive new and updated event data, sports content input, and statistical data throughout the sporting event.

At step 308, the system may determine, using a decision engine (e.g., decision engine 204), recommended statistical odds for the sporting event. The recommended statistical odds may refer to statistical odds determined to be output to a user (e.g., one or more users). The recommended statistical odds may be from the statistical odds received at step 304 and may be determined based on the sports event data from step 306 and/or based on the sports content received from step 302. The determined statistical odds may be determined as unique or interesting (e.g., based on a predetermined threshold, user preference, or the like) to one or more users. The determined statistical odds may further be directly related to a particular sports event data received.

At step 310, the system may determine, using a decision engine (e.g., decision engine 204), based on the received input digital sports content and sports event data, recommended contextual content based on the determined recommended statistical odds. The recommended contextual content may relate to and be used to determine the recommended statistical odds from step 308.

In some examples, step 308 and 310 may be performed simultaneously where recommend statistical odds and recommended contextual content are determined simultaneously by the decision engine.

The decision engine may utilize machine learning techniques to determine the contextual content and/or recommend statistical odds. The decision engine may further utilize rules-based decision making to determine the contextual content and/or recommend statistical odds.

In some examples, the decision engine may include a set of trigger events, wherein the trigger events correspond to particular event data. Upon the occurrence of the trigger event, the system may automatically search for associated preset statistical odds and preset content to output for a user. In an example scenario, a trigger event may be a goal in a soccer game. The recommended statistical odds associated with the trigger event may be an updated statistical odd for a team to win the sporting event and the recommended contextual content may be a video of the goal.

In other examples, the decision engine may utilize one or more machine learning systems to determine recommended contextual content and recommended statistical odds. For example, the machine learning model may be trained on a set of trigger events to determine and generate additional recommended contextual content and recommended statistical odds related to a sporting event. In some embodiments, the machine learning model of the decision engine may be trained using a training data set that includes game files or simulated game files from historical games, historical tracking data, historical event data, simulated games, historical or simulated feature representations, user data representing historical interest levels, engagement levels, or dwell times with particular predictions or insights, and/or the like. The machine learning model of the decision engine may be trained using supervised, semi-supervised, or unsupervised learning. For example, the machine learning model of the decision engine may be trained using the training data set and corresponding (e.g., subsequent) labeled event data. Based on the training data set and corresponding labeled event data, a machine learning algorithm may be used to update weights, layers, nodes, synapsis, and/or basis of the machine learning model of the decision engine to predict actual events based on inference game files, tracking data, event data, games, feature representations, user data, engagement levels, and/or dwell times.

The machine learning model may be configured to assign a score all received content and statistical odds received. The score may correspond to a likelihood of engagement by one or more users.

The decision engine may further be configured to rank determined contextual content and/or recommend statistical odds. The decision engine may utilized the assigned score for the contextual content and/or recommended statistical odds to determine said ranks. For example, in a sporting event, a string of plays may happen including, a first pass, a second pass, a penalty, and a goal across a thirty second time span. The decision engine may be configured to generate contextual content for all actions; however, the decision engine may rank (e.g., assign a higher score) the different determined content and prioritize certain actions, as discussed herein. In this scenario, the decision engine may prioritize outputting content related to the goal as opposed to the passes or penalty. In some examples, the contextual content and/or recommended statistical odds may require a score above a threshold value in order to be output to a user.

The decision engine may further be configured to group one or more (e.g., two, three, four, five, etc.) contextual content at once to output. For example, the system may recommend contextual content that includes at least two types of content, the types of content including: video highlights, news right videos, editorial, insights, graphic visuals, statistics of the one or more sporting events, and/or visual outputs of the one or more sporting events. The system may pair at least two types of content together for output.

At step 312, the system (e.g., the display generation module 140 and transmission module 142) may output the recommended contextual content and/or recommended statistical odds to one or more users. This may be outputted to a user interface in a live-feed format. For example, the system (e.g., the computing system 104) may retrieve a template (e.g., template(s) 128) to format and output a sports information card (e.g., sports information card 130) of the recommended contextual content and/or recommended statistical odds and output this as a story (e.g., story 131) of an output feed.

In some examples, the recommended contextual content and/or recommended statistical odds may be output upon having a score above a threshold value. In some examples, a set of recommended contextual content and/or recommended statistical odds may be determined in a period of time by implementing the techniques of method of steps 302 to 310. The decision engine may determine an order of how to output the recommended contextual content and/or recommended statistical odds. For example, the corresponding score assigned to the recommended contextual content and/or recommended statistical odds may predict a level of user engagement. In some examples, the recommended contextual content and/or recommended statistical odds may be output based on the assigned score (e.g., higher scores are displayed first and a top of a feed). In another example, one or more of the machine learning systems in the decision engine may be refined to generate user specific scores, where the score is meant to reflect a particular user's likelihood of engagement based on past. For example, particular users may interact with certain types of content and statistical odds at a higher rate. The machine learning model may learn (e.g., be trained on) these past actions and incorporate these into the user specific scores. In this scenario, a decision engine may prioritize outputting recommended contextual content and/or recommended statistical odds with higher user specific scores.

The method of FIG. 3 may be applied throughout a sporting event. This may lead to multiple sets of recommended content and recommended statistical odds being output to one or more users. New sets of recommended content and recommended statistical odds may be determined throughout a sporting event and constantly uploaded to a user interface. The output may be updated throughout the sporting event. This could take the form of a ‘scrolling news feed’ such that the user would continually see updated content as it is produced/as the game progresses. This may be a paradigm shift for the consumption of this type of content which is normally served on a ‘pull to refresh’ basis or a ‘periodic refresh’ basis—both of which may fail to capture the excitement of live sport. As new contextually triggered content is produced it may display at the top of said feed, pushing older updates down the page. The experience may easily be augmented by adding functionality such as filters (for certain types of content, players or match events) and search functionality.

In some examples, additional actions may occur after the outputting of recommended contextual content and/or recommended statistical odds. For example, a user may respond and/or interact with the recommended contextual content and/or recommended statistical odds. For example, a user may watch a video or interact with the recommended statistical odds. In some examples, the decision engine may generate additional recommended contextual content and/or recommended statistical odds related to the original recommended contextual content and/or recommended statistical odds. For example, if a user watched a video of player x scoring a goal, then the decision engine may further output an editorial/insight/written description of the goal to the user.

In another example, the decision engine may automatically, upon outputting the recommended statistical odds, generate a slip for a user to interact with the statistical odd. For example, an interactive user interface may provide the user the option to immediately enter a bet and create a bet slip with one click.

In some examples, upon interacting with the recommended contextual content and/or recommended statistical odds, the decision engine may be refined for general scores and user specific scores. This may allow the decision engine to constantly generate/recommend the most relevant content.

As will be described in FIG. 4 below, a user may manually enter one or more trigger events and corresponding recommended contextual content and/or statistical odds to output. This may allow for users to specifically request particular recommended contextual content and recommended statistical odds upon the occurrence of particular event data.

FIG. 4 is an exemplary box diagram 400 representing a trigger event and desired output for the sports content provider environment, according to example embodiments. The box diagram 400 may display how a trigger event may be uploaded to the decision engine. As shown as a desired input 402, a user may select a player/team, a statistics category (e.g., a particular piece of event data), an operator, and threshold amount.

The statistical categories for a team may include score, passes, penalties, time of possession, injury report, etc. The select statistic category for a player may include shots, goals, passes, assists, penalties, time on the field, etc.). Further, operators may be assigned to particular received event data. The operators may include equal to, greater than, greater than or equal to, less than, and less than or equal to. These operators may be utilized by the decision engine to determine when and what outputs to generate. The threshold may refer to a particular value that must occur relevant to an operator in order for the decision engine to generate an output. For example, the user could input a trigger event for “team A”, scores goals, greater than 3. This can be the event that the decision engine will search for during a sporting event.

The desired output 404 (e.g., recommended contextual content) may refer to content such as video highlights, news right videos, editorials, insights, graphic visuals, statistics, and vision to output when the trigger event occurs. This content may be created by, calculated by, and/or provided by the system. The desired output 404 may also include particular statistical outputs related to the teams and players in a sporting event. For example, this may include what type of statistical odd to output with the desired input.

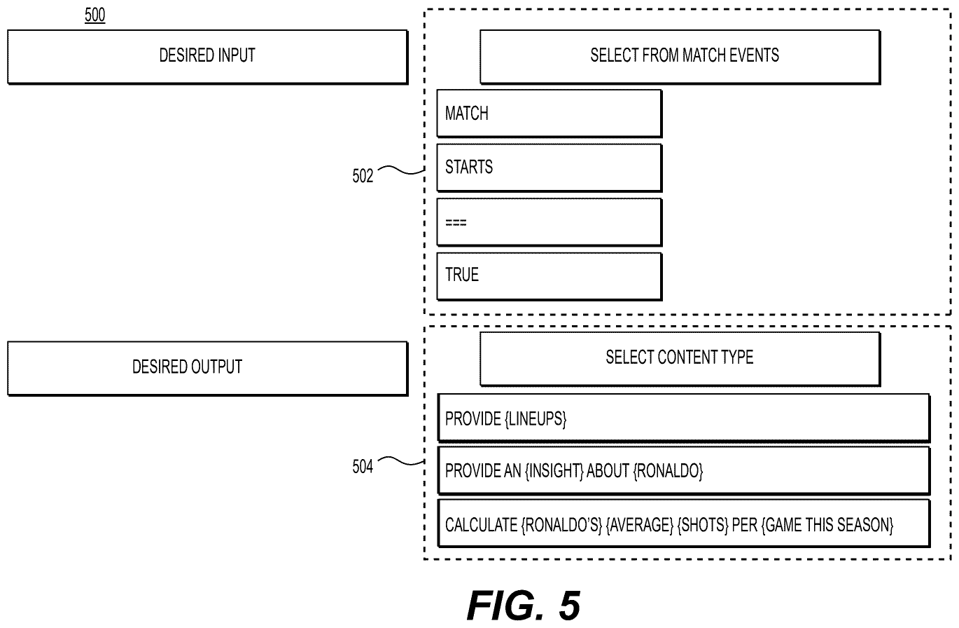

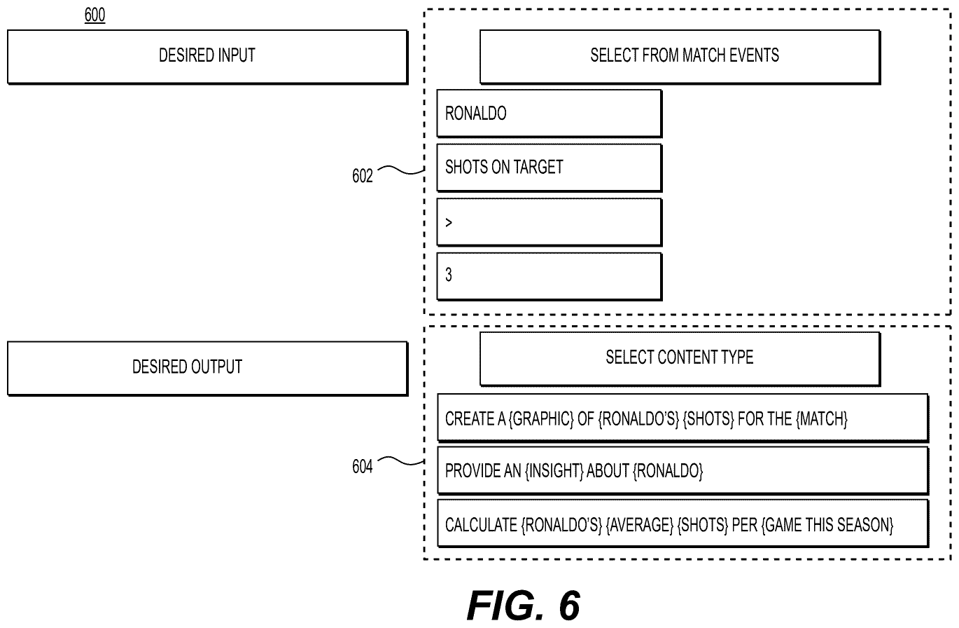

FIG. 5 and FIG. 6 depict exemplary trigger event scenarios that the content provider environment 200 may determine and the corresponding outputs. FIG. 5 is an exemplary flow diagram 500 of the sports content provider's output during a sporting event, according to example embodiments. The flow diagram 500 may be implemented by the content provider environment 200 of FIG. 2 and/or environment 100 of FIG. 1.

In FIG. 5, during an exemplary sporting event, the content provider environment may receive as input 502 event data that a match has begun (e.g., the assigned value of whether a match as started may be updated as true). This may, for example, be received by the event engine inputs 226. Upon receiving this input, the decision engine may be configured to determine a particular output. For example, the output 504 may include the lineups of each team for the sporting event, an insight about a particular player from each starting lineup, and a generated statistic may be output. For example, the average shots per game performed by a particular player may be output.

FIG. 6 is an exemplary flow diagram 600 of the sports content provider's output based on a player's actions (e.g., as defined by event data) during a sporting event, according to example embodiments. The flow diagram 600 may be implemented by the content provider environment 200 of FIG. 2 and/or environment 100 of FIG. 1.

In FIG. 6, during a sporting event, the content provider environment may receive as input event data indicating an occurrence of a player's (i.e. Ronaldo) shots on target. For example, the system may receive input 602 of event data that a player has performed a set number of shots. This may for example be received by the event engine inputs 226. Upon receiving this input 602, the decision engine may be configured to determine a particular output. For example, the output 604 may include a graphic of the players' shots performed during the match, an insight created for the player, and/or a calculation regarding the player's shots per goal for a season. This generated output may be sent to a user interface. The graphic may be formatted such that the insight is associated with corresponding content provided as part of the content input 210.

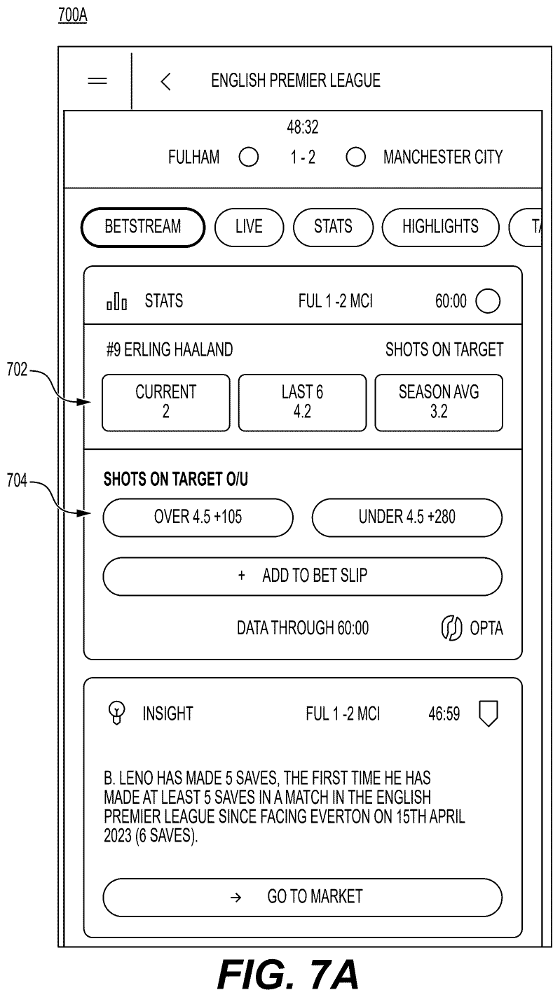

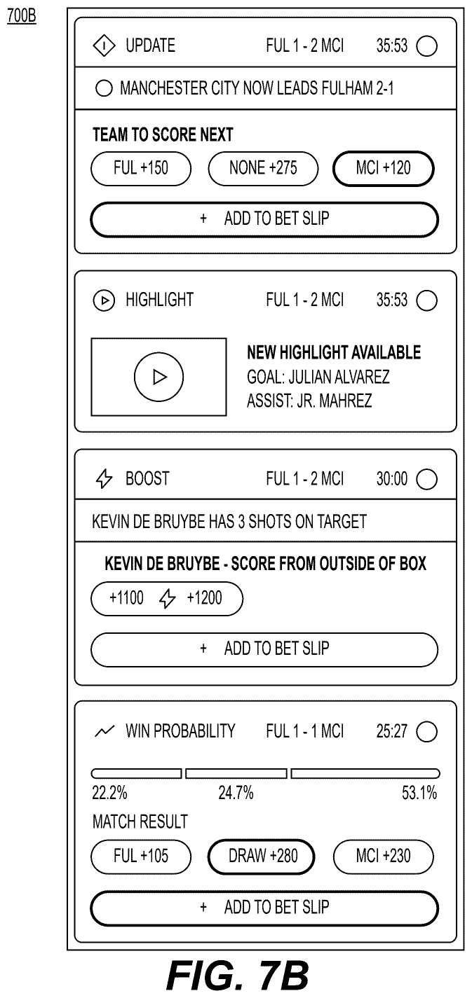

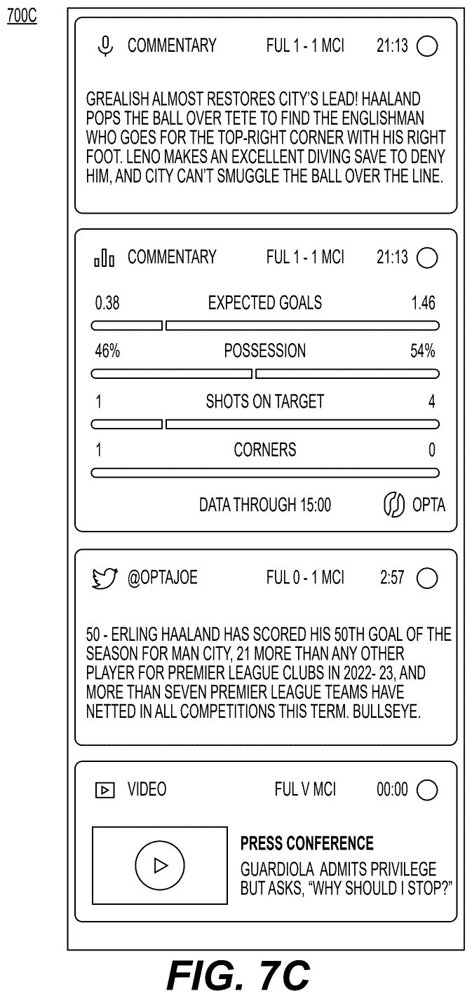

FIG. 7A-7C are exemplary block diagrams 700A, 700B, and 700C of a user interface output, according to example embodiments. The block diagrams 700A, 700B, and 700C may represent an exemplary stream of outputs generated by the content provider environment 200 and/or environment 100 as described herein. The block diagrams 700A included an exemplary recommended contextual content 702 corresponding to shots on target by a current player (e.g., a statistic), along with a season average, and an average over the last six games. The block diagram 700A further includes a corresponding recommended statistical odd 704 corresponding to the predicted amount of shots (e.g., the over/under) for the player in the current sporting event. Block diagram 700B and 700C depict further recommended statistical odds and recommended contextual content that may be generated and output by the decision engine through an exemplary sporting event.

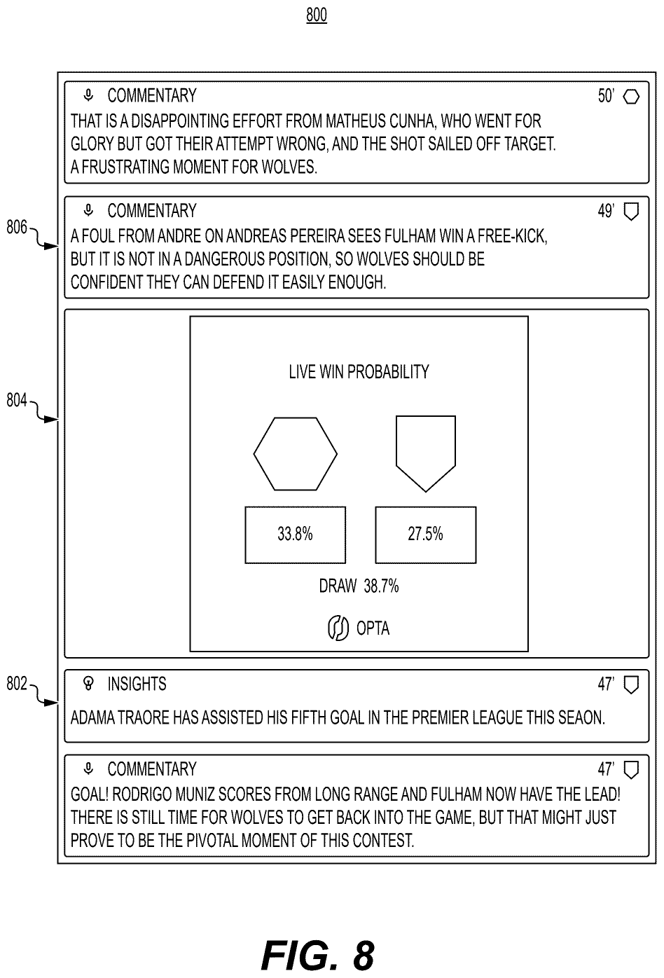

FIG. 8 is an exemplary block diagram 800 of a user interface output including statistical odds and commentary, according to example embodiments. The block diagram 800 may represent an exemplary stream of outputs generated by the content provider environment 200 and/or environment 100 as described herein. In block diagram 800, a statistic that a player has assisted on a fifth goal for the season and commentary 806 for a next play may be output as exemplary recommended contextual content 802. Further in block diagram 800, a live win probability may be output as a recommended statistical odd 804. Further, insight related to the sporting event may be output as exemplary recommended contextual content 802.

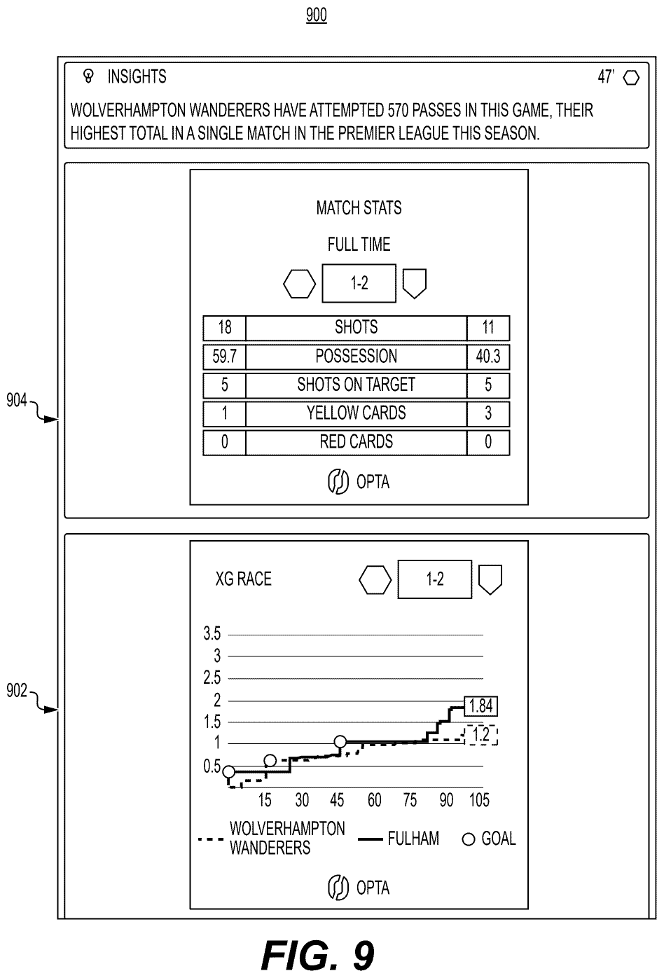

FIG. 9 is an exemplary block diagram 900 of a user interface output including statistical odds and match statistics, according to example embodiments. The block diagram 900 may represent an exemplary stream of outputs generated by the content provider environment 200 and/or environment 100 as described herein. In block diagram, a xG prediction 902 for both teams in combination with team statistic 904 may be output as recommended statistical odds. The xG prediction may refer to a likelihood of success of a goal scoring performance. The xG may be assigned to actions in a sporting event, such as a direct kick from a particular area. The xG score may be a continuous value between 0 and 1. This may be generated by a separate machine learning model. The xG may be an exemplary recommended contextual content.

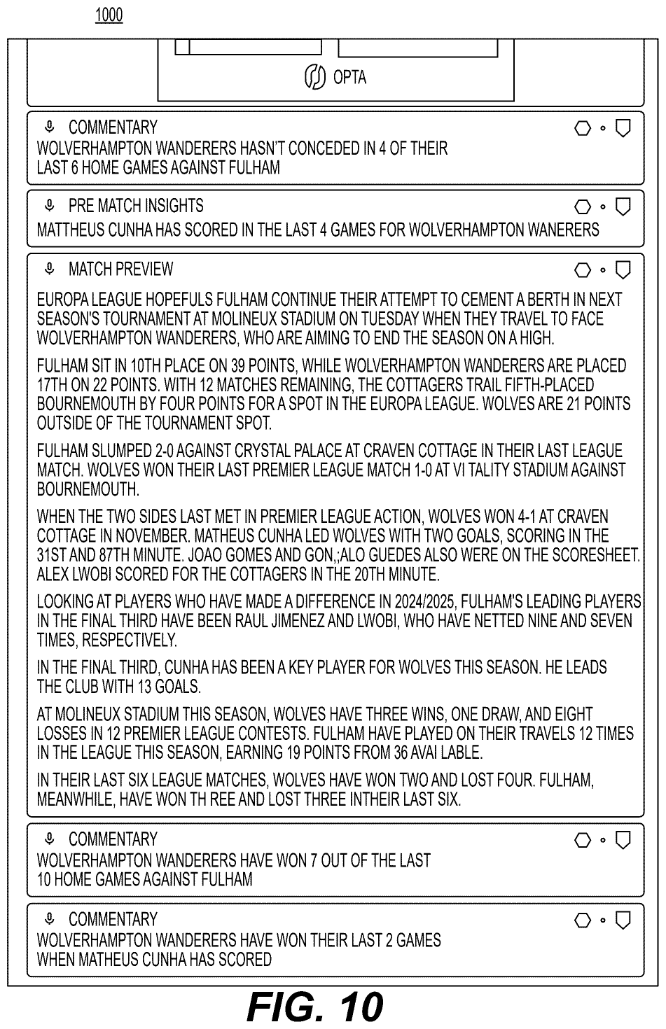

FIG. 10 is an exemplary block diagram 1000 of a user interface output including a match preview, according to example embodiments. The block diagram 1000 may represent an exemplary stream of outputs generated by the content provider environment 200 and/or environment 100 as described herein. For example, this may be generated and output prior to event data indicating the start of a sporting event is received.

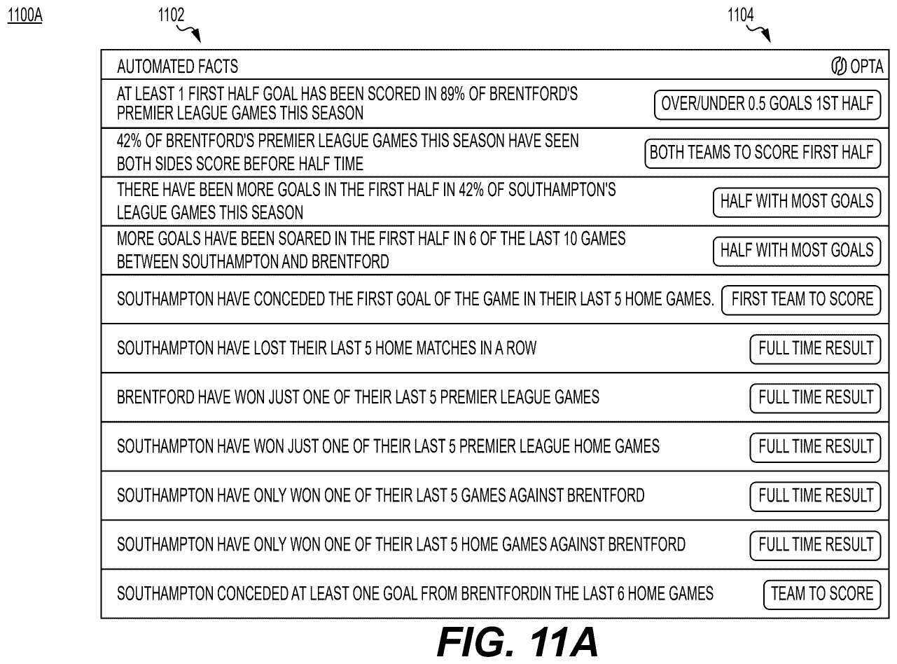

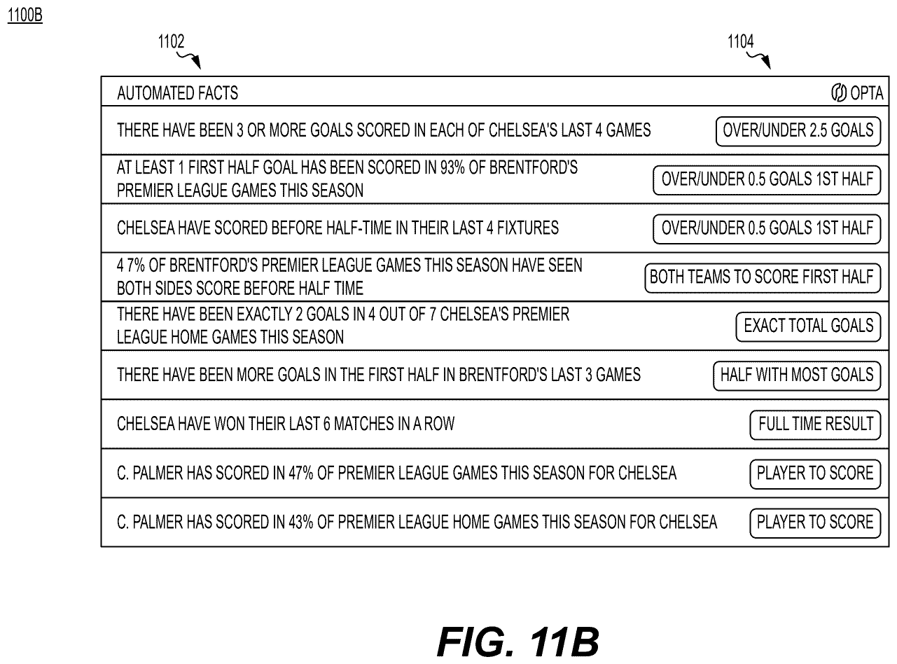

FIG. 11A-11B are exemplary block diagrams 1100A, 1100B of a user interface output including facts and corresponding statistical odds, according to example embodiments. The block diagram 1100A, 1100B may include a template format for output of the decision engine which includes automate facts 1102 corresponding to recommended contextual content on a left column. The template may further include recommended statistical odds 1104 corresponding to each of the automated facts on the right column.

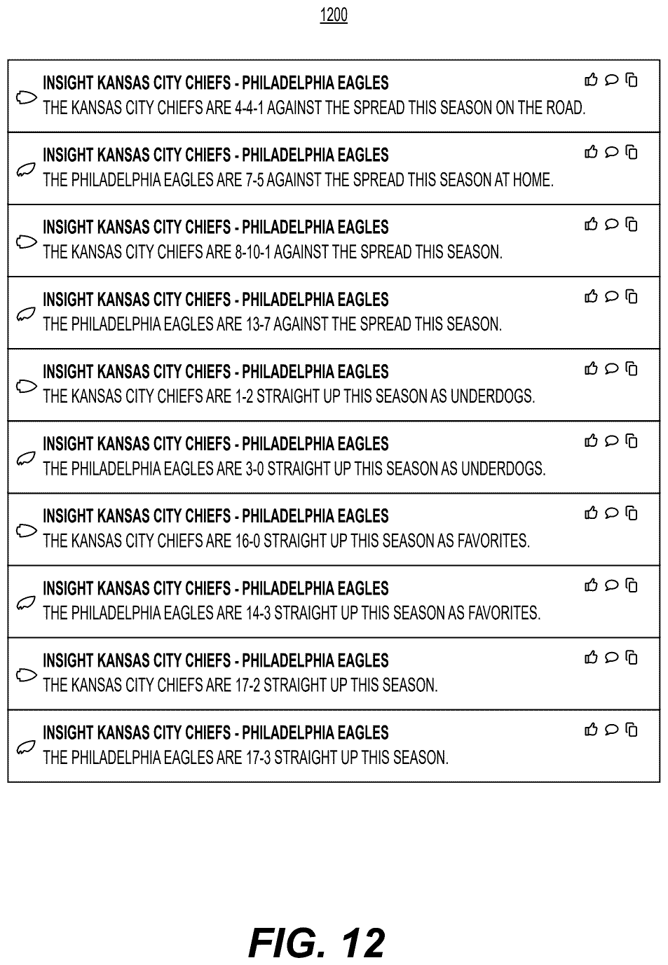

FIG. 12 is an exemplary block diagram of a user interface output including statistical odds and corresponding statistics, according to example embodiments. The block diagram 1200 may represent an exemplary stream of outputs generated by the content provider environment 200 and/or environment 100 as described herein. For example, the relevant insights from block diagram 1200 may correspond to recommend contextual content and may each include corresponding recommended statistical odds (not shown).

In another example of the content provider environment 200, the content provider environment 200 may receive as input that a player A just had their 4th shot from outside the box in a particular soccer game B. The content provider environment may have received previous statistics that, on average, over the course of the season, player A averages one goal outside the box for every 5th shot they take. The player A's rate of goals to shots from outside the box is higher than average in this match.

The statistics odds for this player to score outside the box may have moved from 5/1 to 6/1 in the last 5 minutes. This statistical data may be received along with the event data by the decision engine. The decision engine may be configured to calculate updated statistics this in real time, and determined that the updated statistic is highly relevant and contextual at this moment (because of the original data point of taking the 4th shot outside the box) and outputs the updated statistic along with the content related to the goal (e.g., a video highlight and/or a statistics) and output the recommended statistic and content for end user consumption (end user being a customer or frontend application).

In another example of the content provider environment 200, player C may have just scored in a soccer game D. The score of the sporting event D may be 1-1 and there may be twenty minutes left in the match. All of this event data may be uploaded to the decision engine.

Upon receiving this event data, the decision engine may generate recommended statistics and contextual content for output. For example, the data engine may calculate that player C goes on to score twice against this team when scoring once before 70 minutes, 75% of the time (e.g., this may be based on the received historical statistics for the player). This data may be converted into an insight for public consumption.

A highlight video may automatically be clipped from the live stream of the match, using the goal time as a marker and then calculating an appropriate before/after clip time. The clip may be provided by the API for output at the same time. Further, a statistical odd or sports book market for the player to score twice may be output and promoted to users through the API at the same time. A graphic may automatically be generated with the players' shot map for the match.

These four outputs may be bundled into a ‘packet’ to be delivered as part of a single unified feed. These outputs may be displayed on the front end sequentially, along with similar output from other matches, to create a ‘live news feed’ style experience.

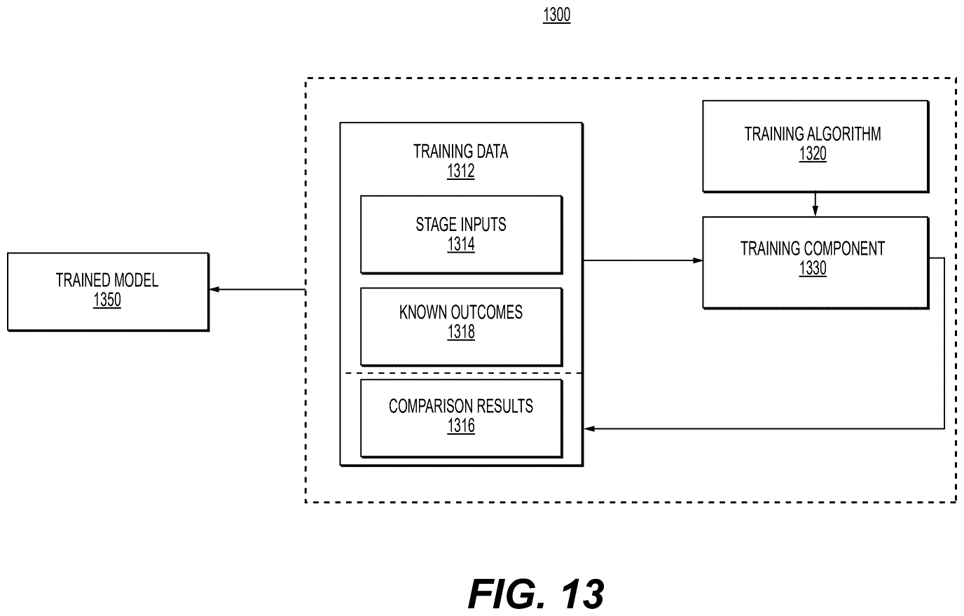

FIG. 13 depicts a flow diagram for training a machine learning model, in accordance with an aspect of the disclosed subject matter. As shown in flow diagram 1300 of FIG. 13, training data 1312 may include one or more of stage inputs 1314 and known outcomes 1318 related to a machine learning model to be trained. The stage inputs 1314 may be from any applicable source including a component or set shown in the figures provided herein. The known outcomes 1318 may be included for machine learning models generated based on supervised or semi-supervised training. An unsupervised machine learning model might not be trained using known outcomes 1318. Known outcomes 1318 may include known or desired outputs for future inputs similar to or in the same category as stage inputs 1314 that do not have corresponding known outputs.

The training data 1312 and a training algorithm 1320 may be provided to a training component 1330 that may apply the training data 1312 to the training algorithm 1320 to generate a trained machine learning model 1350. According to an implementation, the training component 1330 may be provided comparison results 1316 that compare a previous output of the corresponding machine learning model to apply the previous result to re-train the machine learning model. The comparison results 1316 may be used by the training component 1330 to update the corresponding machine learning model. The training algorithm 1320 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1300 may be a trained machine learning model 1350.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein.

According to an implementation, one or more machine learning models disclosed herein may continuously update based on feedback associated with use or implementation of the machine learning model outputs.

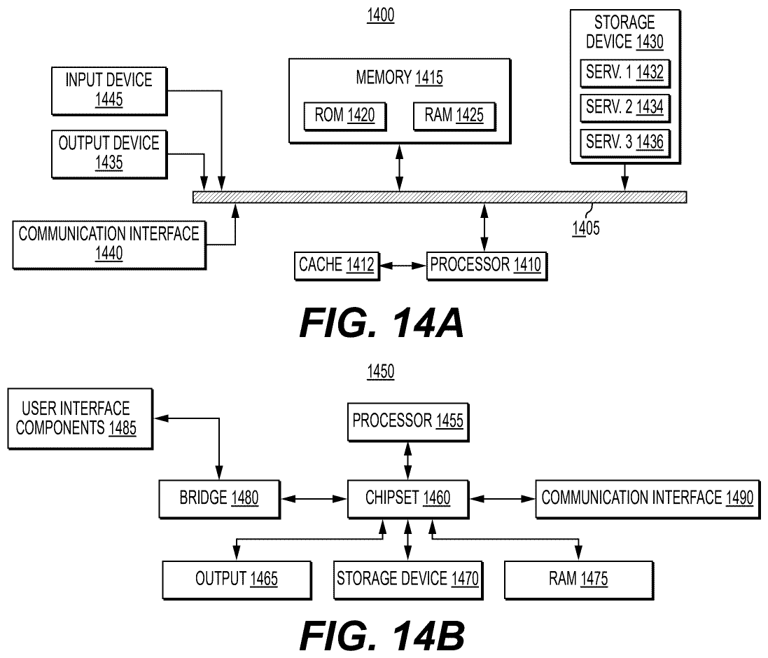

FIG. 14A illustrates an architecture of computing system 1400, according to example embodiments. System 1400 may be representative of at least a portion of organization computing system 104. One or more components of system 1400 may be in electrical communication with each other using a bus 1405. System 1400 may include a processing unit (CPU or processor) 1410 and a system bus 1405 that couples various system components including the system memory 1415, such as read only memory (ROM) 1420 and random access memory (RAM) 1425, to processor 1410. System 1400 may include a cache of high-speed memory connected directly with, in close proximity to, or integrated as part of processor 1410. System 1400 may copy data from memory 1415 and/or storage device 1430 to cache 1412 for quick access by processor 1410. In this way, cache 1412 may provide a performance boost that avoids processor 1410 delays while waiting for data. These and other modules may control or be configured to control processor 1410 to perform various actions. Other system memory 1415 may be available for use as well. Memory 1415 may include multiple different types of memory with different performance characteristics. Processor 1410 may include any general purpose processor and a hardware module or software module, such as service 1 1432, service 2 1434, and service 3 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction with the computing system 1400, an input device 1445 may represent any number of input mechanisms, such as a microphone for speech, a touch-sensitive screen for gesture or graphical input, keyboard, mouse, motion input, speech and so forth. An output device 1435 (e.g., display) may also be one or more of a number of output mechanisms known to those of skill in the art. In some instances, multimodal systems may enable a user to provide multiple types of input to communicate with computing system 1400. Communications interface 1440 may generally govern and manage the user input and system output. There is no restriction on operating on any particular hardware arrangement and therefore the basic features here may easily be substituted for improved hardware or firmware arrangements as they are developed.

Storage device 1430 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1425, read only memory (ROM) 1420, and hybrids thereof.

Storage device 1430 may include services 1432, 1434, and 1436 for controlling the processor 1410. Other hardware or software modules are contemplated. Storage device 1430 may be connected to system bus 1405. In one aspect, a hardware module that performs a particular function may include the software component stored in a computer-readable medium in connection with the necessary hardware components, such as processor 1410, bus 1405, output device 1435, and so forth, to carry out the function.

FIG. 14B illustrates a computer system 1450 having a chipset architecture that may represent at least a portion of organization computing system 104. Computer system 1450 may be an example of computer hardware, software, and firmware that may be used to implement the disclosed technology. System 1450 may include a processor 1455, representative of any number of physically and/or logically distinct resources capable of executing software, firmware, and hardware configured to perform identified computations. Processor 1455 may communicate with a chipset 1460 that may control input to and output from processor 1455. In this example, chipset 1460 outputs information to output 1465, such as a display, and may read and write information to storage device 1470, which may include magnetic media, and solid-state media, for example. Chipset 1460 may also read data from and write data to RAM 1475. A bridge 1480 for interfacing with a variety of user interface components 1485 may be provided for interfacing with chipset 1460. Such user interface components 1485 may include a keyboard, a microphone, touch detection and processing circuitry, a pointing device, such as a mouse, and so on. In general, inputs to system 1450 may come from any of a variety of sources, machine generated and/or human generated.

Chipset 1460 may also interface with one or more communication interfaces 1490 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1455 analyzing data stored in storage device 1470 or RAM 1475. Further, the machine may receive inputs from a user through user interface components 1485 and execute appropriate functions, such as browsing functions by interpreting these inputs using processor 1455.

It may be appreciated that example systems 1400 and 1450 may have more than one processor 1410 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for generating recommended user content related to a sporting event, the method comprising:
receiving, as input, digital sports content of one or more sporting events;
receiving, as input, sports event data for the one or more sporting events;
receiving, as input, a set of statistical odds for the one or more sporting event;
determining, using a decision engine, based on the received input digital sports content and sports event data, recommended statistical odds for one or more sporting events;
determining, using the decision engine, recommended contextual content based on the determined recommended statistical odds; and
outputting the recommended contextual content and recommended statistical odds to one or more users.

2. The method of claim 1, wherein the recommended statistical odds are determined from the set of statistical odds.

3. The method of claim 1, wherein the digital sports content includes: video highlights, news right videos, editorial, insights, graphic visuals, statistics of the one or more sporting events, and/or visual outputs of the one or more sporting events.

4. The method of claim 1, wherein the sports event data includes real time statistical data for the one or more sporting events.

5. The method of claim 1, further including:
receiving as input, a second set of sports event data for the one or more sporting events; a second set of digital sports content of the one or more sporting event, and a second set of statistical odds for the one or more sporting event;
determining, using the decision engine, a second set of recommended contextual content and second set of recommended statistical odds for the one or more sporting events; and
outputting the second set of recommended contextual content and second set of recommended statistical odds to the one or more users.

6. The method of claim 1, wherein the decision engine uses machine learning techniques to determine at least one of the recommended statistical odds or the recommended contextual content.

7. The method of claim 1, wherein the decision engine uses rules-based decision making techniques to determine at least one of the recommended statistical odds or the recommended contextual content.

8. The method of claim 1, further including:
determining at least two recommended contextual content outputs;
ranking the two recommended contextual content outputs based on determined relevance; and
outputting a higher ranked of the two recommended contextual content outputs.

9. The method of claim 1, wherein the recommended contextual content includes at least two types of content, the types of content including: video highlights, news right videos, editorial, insights, graphic visuals, statistics of the one or more sporting events, and/or visual outputs of the one or more sporting events; and
pairing the at least two types of content together for output.

10. The method of claim 1, wherein the recommended contextual content includes a visual graphic created to depict the received sports event data.

11. A system for associating a player with a team in a sports event, the system comprising:
a memory configured to store processor-readable instructions; and
a processor operatively connected to the memory, and configured to execute the instructions to perform operations comprising:
receiving, as input, digital sports content of one or more sporting events;
receiving, as input, sports event data for the one or more sporting events;
receiving, as input, a set of statistical odds for the one or more sporting event;
determining, using a decision engine, based on the received input digital sports content and sports event data, recommended statistical odds for one or more sporting events;
determining, using the decision engine, recommended contextual content based on the determined recommended statistical odds; and
outputting the recommended contextual content and recommended statistical odds to one or more users.

12. The system of claim 11, wherein the recommended statistical odds are determined from the set of statistical odds.

13. The system of claim 11, wherein the digital sports content includes: video highlights, news right videos, editorial, insights, graphic visuals, statistics of the one or more sporting events, and/or visual outputs of the one or more sporting events.

14. The system of claim 11, wherein the sports event data includes real time statistical data for the one or more sporting events.

15. The system of claim 11, wherein the operations further comprise:
receiving as input, a second set of sports event data for the one or more sporting events; a second set of digital sports content of the one or more sporting event, and a second set of statistical odds for the one or more sporting event;
determining, using the decision engine, a second set of recommended contextual content and second set of recommended statistical odds for the one or more sporting events; and
outputting the second set of recommended contextual content and second set of recommended statistical odds to the one or more users.

16. The system of claim 11, wherein the decision engine uses machine learning techniques to determine at least one of the recommended statistical odds or the recommended contextual content.

17. The system of claim 11, wherein the decision engine uses rules-based decision making techniques to determine at least one of the recommended statistical odds or the recommended contextual content.

18. A non-transitory computer readable medium configured to store processor-readable instructions, wherein when executed by a processor, the instructions perform operations comprising:
receiving, as input, digital sports content of one or more sporting events;
receiving, as input, sports event data for the one or more sporting events;
receiving, as input, a set of statistical odds for the one or more sporting event;
determining, using a decision engine, based on the received input digital sports content and sports event data, recommended statistical odds for one or more sporting events;
determining, using the decision engine, recommended contextual content based on the determined recommended statistical odds; and
outputting the recommended contextual content and recommended statistical odds to one or more users.

19. The non-transitory computer readable medium of claim 18, wherein the recommended statistical odds are determine from the set of statistical odds.

20. The non-transitory computer readable medium of claim 18, wherein the digital sports content includes: video highlights, news right videos, editorial, insights, graphic visuals, statistics of the one or more sporting events, and/or visual outputs of the one or more sporting events.
